(19) United States
(12) Patent Application Publication
(10) Pub. No.: US 2021/0204040 A1
(43) Pub. Date: Jul. 1, 2021

(54) Dynamic Video Scraping Systems and Methods

(71) Applicant: Clipkick, Inc., Venice, CA (US)

(72) Inventors: Alan Edwards, Los Angeles, CA (US); Milan Mendpara, Surat (IN); Alpesh Khunt, Ahmedabad (IN)

(21) Appl. No.: 17/200,816

(22) Filed: Mar. 13, 2021

Related U.S. Application Data
(63) Continuation-in-part of application No. 16/383,545, filed on Apr. 12, 2019.
(60) Provisional application No. 62/989,519, filed on Mar. 13, 2020.

(51) Int. Cl. H04N 21/858; H04N 21/2743; H04N 21/235

(52) U.S. Cl. CPC H04N 21/8586; H04N 21/235; H04N 21/2743

(57) ABSTRACT

Systems and methods of the inventive subject matter are directed to aggregating video content for viewing in, e.g., an app with access to a service platform. Embodiments of the inventive subject matter facilitate collecting video URLs from webpages having video content when those video URLs are otherwise inaccessible to an ordinary scraper. Embodiments include the steps of determining, by the service platform, whether a video URL is readily accessible in a webpage, and, if not, executing a script based on the webpage's domain to discover or create a video URL. In some embodiments, the systems and methods of the inventive subject matter are further configured to handle embedding and playback of video content that is accessed via video URL.

### FIELD OF THE INVENTION

The field of the invention is metadata scraping for a video content aggregation platform.

### BACKGROUND

The background description includes information that may be useful in understanding the present invention. It is not an admission that any of the information provided in this application is prior art or relevant to the presently claimed invention, or that any publication specifically or implicitly referenced is prior art.

Before the proliferation of online video made accessible on webpages, it was relatively simple for search engines and aggregators to index webpages. When a webpage was scraped for metadata (e.g., page links, meta tags, text and image URLs), that metadata could be extracted with a general “scraper” script that worked well for most webpages. Such a script could be deployed around the internet in a robotic fashion in the form of a “crawler,” or it could be manually activated by a user when that user, for example, adds a bookmark or otherwise saves information on or about a webpage. Webpage information could then be stored in a database and later found by a user either through a search or other means, which would allow the user to re-access the page or contents, such as text and images. Users have also found utility in aggregator solutions that isolate text (e.g., Google) or images (e.g., Pinterest) from a webpage for later access.

As internet technology advances, webpage video content has become increasingly ubiquitous. Faster internet connections and convenient embedding solutions provided by video platforms has made it easy for web publishers to include videos on their webpages and for viewers to enjoy them as they browse the page. Thus, online video distribution on the internet has experienced explosive growth.

Video content publishers stand to benefit from improved video content sharing systems and methods. Publishers have incentives to support extraction and sharing of links to videos hosted on their platforms into video aggregators (e.g., websites or apps that aggregate video content), as this allows those publishers to get more views for their videos. Since content publishers' advertising partnerships and efforts (e.g., ad servers) deliver ads when their video URLs are used to access or view video content, publishers make incremental revenue when their links are extracted and placed in video aggregators like those described in this application. Video content publishes also stand to benefit from improved systems and methods capable of extracting video links from their webpages, where those systems and methods do not necessitate modifying webpage code.

A need has thus arisen to create a video-based content aggregator to extract reference links of videos embedded on webpages to create a platform for people to watch those videos independently of the webpage on which they can ordinarily be accessed. The ability to aggregate videos source links and play the associated videos on a single platform streamlines the video watching experience for users interested in watching videos, while allowing both ordinary users and web publishers to reach a wider audience for their video content.

### SUMMARY OF THE INVENTION

The present invention provides apparatuses, systems, and methods directed to video content aggregation. In one aspect of the inventive subject matter, a method of aggregating video content to a service platform comprises the steps of: receiving, by the service platform from a client device, video metadata corresponding to a video accessible via a video content source; analyzing, by the service platform, the video metadata to extract a video URL from the video metadata; and saving the video URL to a database.

In some embodiments, the step of making the video accessible to other users by making the video URL stored in the database accessible to the other users of the service platform. In some embodiments, the video content source includes at least one of a webpage and a standalone application. The video metadata can include a URL, and, in some embodiments, the method can additionally include the step of transmitting, by the service platform, the video URL to the client device. In some embodiments, the step of extracting the video URL includes creating the video URL using at least a portion of the video metadata.

In another aspect of the inventive subject matter, a method of aggregating video content to a service platform is contemplated, the method comprising the steps of: receiving, by the service platform from a crawler, video metadata corresponding to a video that is accessible via a video content source; detecting, by the service platform, whether a video URL can be extracted or created using the video metadata; upon determining the video URL cannot be extracted or created using the video metadata, identifying a custom script configured to extract the video URL; wherein the custom script is identified based on at least a domain of the video content source; executing the custom script; and saving, by the service platform, the video URL to a database.

In some embodiments, the methods also includes the step of making the video accessible to other users by making the video URL stored to the database accessible to the other users of the service platform. In some embodiments, the video content source comprises at least one of a webpage and a standalone application. The video metadata can include a URL, and in some embodiments, the step of executing the custom script also includes creating the video URL using at least a portion of the video metadata.

In another aspect of the inventive subject matter, another method of aggregating video content to a service platform is contemplated, the method comprising the steps of: receiving, by the service platform from a client device, video metadata corresponding to a video that is accessible via a video content source; detecting, by the service platform, whether a video URL can be extracted or created using the video metadata; upon determining the video URL cannot be extracted or created using the video metadata, identifying a custom script configured to extract the video URL; wherein the custom script is identified based on at least a domain of the video content source; executing the custom script; and saving, by the service platform, the video URL to a database.

In some embodiments, the method also includes the step of making the video accessible to other users by making the video URL stored to the database accessible to the other users of the service platform. In some embodiments, the video content source comprises at least one of a webpage and a standalone application. The video metadata can include a URL, and, in some embodiments, the method also includes the step of transmitting, by the service platform, the video URL to the client device. In some embodiments, the step of executing the custom script also involves creating the video URL using at least a portion of the video metadata.

One should appreciate that the disclosed subject matter provides many advantageous technical effects including facilitating the handling, embedding, and ultimate playback of videos from a wide variety of video platforms, websites, and publishers.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic showing the different hardware components that interact in embodiments of the inventive subject matter.

FIG. 2 is a flowchart showing methods steps of an embodiment of the inventive subject matter as accessed by a client device.

FIG. 3 is a flowchart showing methods steps of an embodiment of the inventive subject matter as accessed by a crawler.

FIG. 4 is a schematic showing how an end-user application can make a video selection to display a video.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by an embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Embodiments of the inventive subject matter are directed to systems and methods that facilitate making video content from webpages and other applications available to users of a service platform, whether those webpages make a URL for the video content easily accessible or not. Because, for example, video URLs are not always easily accessible on a given website, a need exists for systems and methods that can nevertheless extract or create a video URL (e.g., a URL pointing a video file, a video embed link, or a URL sufficient to facilitate video embedding) to make this kind of video content available on a service platform. Service platforms of the inventive subject matter can be described as, and function as, a video aggregating platform comprising software running on one or more servers as well as an application running on one or more computing devices such as a smart phone or tablet. In some embodiments, the application is an over-the-top (OTT) media service, and it can also be a web-based application that runs through a web browser.

To independently display videos found on webpages or in other applications on an aggregation platform, a source or embed link pointing to the video (e.g., a video URL) must be extracted (e.g., from a webpage or application). Unlike the task of extracting text and image links, the task of extracting video URLs can be complex. Video URLs take a variety of different forms and are delivered in webpages in a variety of different ways that can be unique to webpage configurations. For example, a video URL can be injected by JavaScript, making the video URL inaccessible to a typical scraper or crawler, or a video URL can be partially delivered and later combined with a publisher video player link to function. Because there can exist added complexity in extracting video URLs, a general scraper script is insufficient for many webpages, thus giving rise to a need for specialized systems and methods directed to extracting or creating video URLs corresponding to video content found on, e.g., a website that otherwise does not make such a URL accessible.

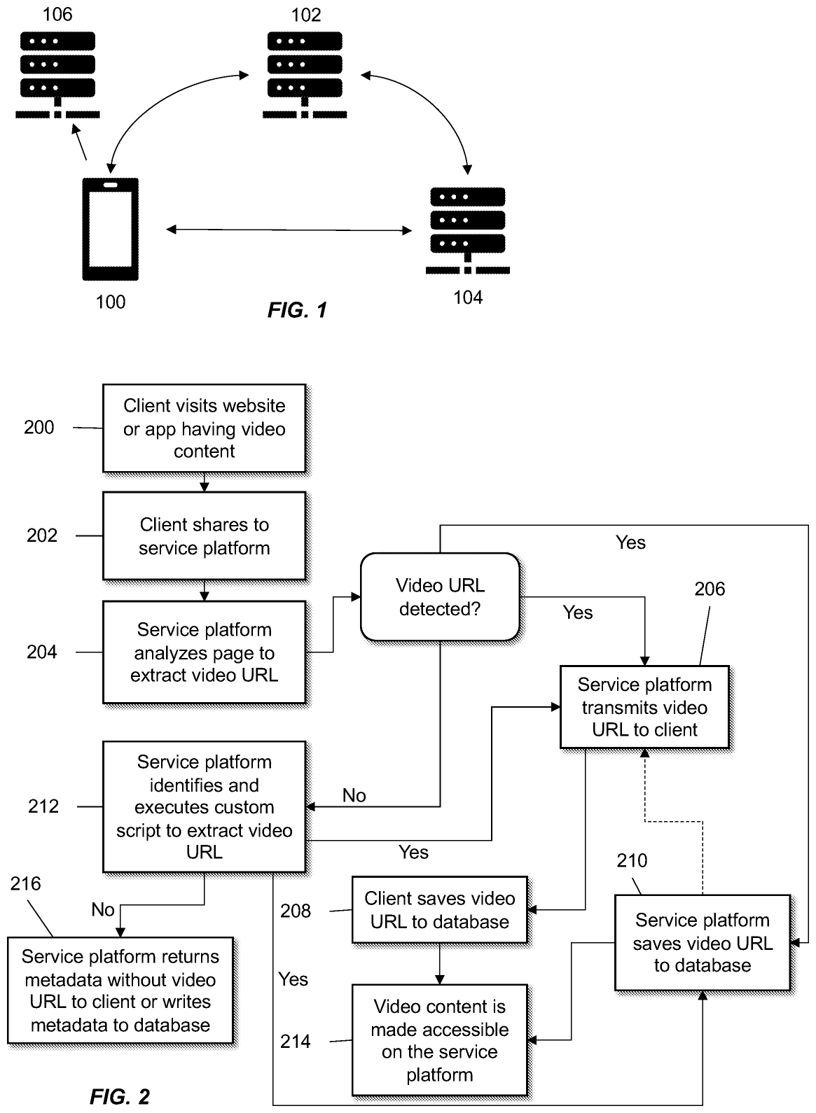

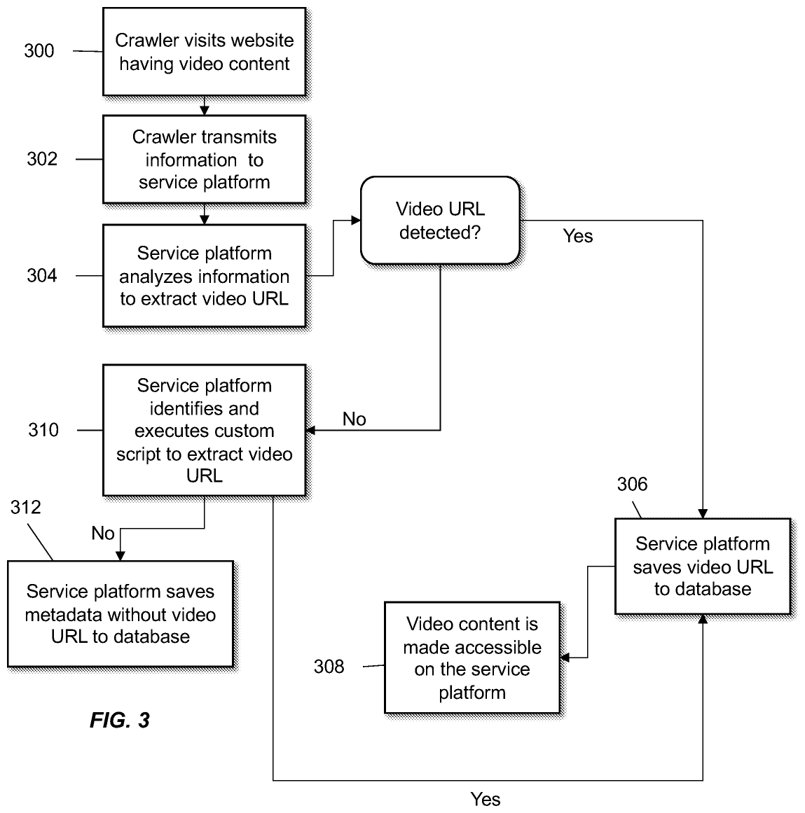

To collect video URLs that are otherwise inaccessible, systems and methods of the inventive subject matter incorporate custom scripts that operate on a domain-by-domain basis. FIG. 1 shows an outline of how information is communicated in the course of executing steps described in FIGS. 2 and 3. FIG. 1 shows a client device 100 (e.g., a smart phone, a computer, a tablet, or any other internet connected computing device), a platform server 102 (e.g., a server, a set of servers, a cloud service, or the like), a website 104 (e.g., a website having video content), and a database 106. Although database 106 is shown as existing separately from platform server 102, it is contemplated that database 106, which is a digital construct, can be stored on platform server 102. A service platform operates on the platform server 102, where the service platform can be, e.g., software executed on platform server 102 to bring both the service platform and one or more apps running on client devices that communicate with the service platform to life.

Thus, when a client device visits a website having video content, and a video URL corresponding to that video content cannot be pulled directly or otherwise easily from the website's source code or metadata, FIG. 2 shows how that video content can nevertheless be captured (e.g., by using a custom script to find a video URL that can be used to access that video content). FIG. 3, on the other hand, shows how a non-human user such as a crawler or scraper can be used to extract or create a video URL from a website.

Systems and methods of the inventive subject matter can be implemented to function in coordination with a client device using either an on-device app or a web-based app, which will be referred to in this application as an “app” in either situation. The app, in this context, comprises a platform for content (e.g., video) sharing, where that platform for content sharing can be maintained by the platform server. The app and service platform together allows users to share videos from a wide variety (theoretically unlimited) of different webpages so that other users on the platform (e.g., using the app) can access those videos within the app without needing to open a separate web browser.

In step 200, as shown in FIG. 2, a user using a client device (the term “user” can be contextually interpreted to mean “client device as controlled by a user” throughout this application) accesses a video source. In embodiments where the video source is a website, video content from the website can easily be shared because a video URL can be accessed from the website's source or metadata. In some cases, websites do not make a video URL immediately available (e.g., the video is not readily scrapable from the website's source code). In other cases, a client device can have an app installed that features video content (e.g., TikTok, YouTube, Vimeo, etc.). In the case of a dedicated video content app, a user opens the app and navigates to some video content, and in the case of a website featuring video content, a user navigates to that website. Once a user has identified video content the user wishes to share, step 202 can take place.

In any case described in this application, whether a user accesses video content via app, website, or some other source of digital video content, video content sources will be described as a “video source” in this application. Although this application expressly contemplates a human user manually bringing video content (e.g., via video URL) into the service platform, e.g., via share function, a non-human user (e.g., a scraper or crawler) can, for example, carry out the functions described in this application as being executed by the user.

Thus, FIG. 2 shows how an embodiment of the inventive subject matter can work when a human user accesses video content via computing device and then attempts to share that content to a platform server of the inventive subject matter. In step 202, the user attempts to bring a video from the video source into the app to, e.g., bookmark it to watch later, make it available to other users, etc. This can be accomplished by, for example, using a “share” feature on the client device and then selecting the app as the target for sharing. In some embodiments, this step can be accomplished by copying a URL from a website or other app and bringing that URL into the app by, e.g., pasting it or by the app detecting a URL on the client device's clipboard. This behavior is typically the same whether a user shares a webpage from a browser or shares video content from a video content app. Thus, when a share button is activated and the app is selected, a URL corresponding to video content can be sent to the app. According to step 204, when the app receives the URL, it accesses the URL and analyzes the webpage the URL points to and the app extracts a video URL that points to the video content that is accessible from the URL. In some embodiments, the service platform analyzes the page accessible via the URL to in an effort to extract a video URL, site/video metadata, a website URL, or any combination thereof.

If the app is able to extract a video URL from the webpage that the URL points to (e.g., a video URL is detected), the service platform can then perform several different tasks. In step 206, for example, when, upon accessing the URL, a video URL is detected, the service platform can transmit the video URL to the client, and then, as described in step 208, the client can then save (e.g., push to a remote server or save locally) the video URL to a database (that is either stored on a remote server or set of servers or locally) so that the video content corresponding to the URL and subsequently the video URL can be made accessible on the service platform, e.g., via dedicated app or web app, as described.

As demonstrated by step 210, in another case when a video URL is detected, the service platform can write the video URL to the database. In some embodiments, after the service platform saves the video URL to the database, it can also transmit the video URL and associated metadata to the client, e.g., to allow the user to select different playlists within the app to add the video content to. This optional action is shown by a dotted line from step 210 to step 206. Thus, the service platform can simultaneously or sequentially send the URL to the client and make the video content accessible on the service platform. Once at least a video URL is stored to the database according to step 210, step 214 describes that video URLs saved to the database make it so users can access that video content via the app. Then app users can watch those videos later and other users can be granted access those videos via the app via embedding and without any need to open a separate web browser or other application to watch the video. This creates a user experience where users can watch an increasingly large library of videos within the app, and where each user can add new videos according to methods of the inventive subject matter even from websites that otherwise make video sharing difficult because video URLs are not readily identifiable.

Thus, when a video URL is detected in step 204, the platform server determines whether a video URL is immediately retrievable using the website URL and then one or both of steps 206 and 210 take over. To check for a video URL, the platform server executes code (e.g., a script or other web-based software code like JavaScript, HTML5, etc.) that looks through the website's source and other metadata to see if a video URL exists and is immediately accessible. In instances where a video URL is not immediately accessible in, e.g., the website's source or metadata, additional steps must be taken to retrieve the video URL. Thus, step 212 is executed when the platform server fails to find a video URL. In step 212, when no video URL is detected, the platform server then attempts to identify a script designed to extract a video URL. Because a video URL can be obfuscated in a variety of different ways, it is frequently the case that no universal script or algorithm can be implemented to retrieve video URLs from any website (e.g., from a particular domain, subdomain, or even particular webpages). To identify a particular script (e.g., software code or portion of a script/software code) to execute to find a video URL in these situations, the platform server looks at the website URL to identify a script based on, e.g., the domain name in the website URL.

Once a script is identified, the platform server executes the script. By executing the script identified according to, e.g., website domain, the platform server can then extract a video URL. For example, if a user wishes to add a video from a webpage on TMZ.com to the app, the platform server determines that a video URL for the video content on TMZ.com is not easily identifiable. Next, the platform server uses a script written specifically for TMZ.com to extract (or, in some instances, create) a video URL. In embodiments where the platform server receives a website URL generated by a separate app (e.g., a link generated by the TMZ app when a video is shared and where that link is then pasted into the content aggregation app of the inventive subject matter, or where the link is detected on the client device's clipboard by the app), the platform server behaves similarly by accessing that URL and checking for a video URL, and when a video URL is inaccessible, it runs a script to extract one. Once a video URL is successfully extracted or created, the service platform can save that video URL to the database according to step 210, and all other steps that can come after step 210 can be followed as well.

In some cases, no video URL can be extracted or created. In these cases, as shown in step 216, the service platform returns metadata without a video URL to the client. The service platform can additionally or alternatively write that metadata to the database. Metadata can include a website URL, a video ID, etc. When a user attempts to access video content having no associated video URL saved to the database, that user can be passed, e.g., a website URL instead. That way users can still watch video content that lacks an associated video URL by opening a browser to view the content. In some embodiments, the app features a built-in web browser capable of opening website URLs and playing video content.

Scripts of the inventive subject matter can be written in, e.g., Python or another suitable language (e.g., JavaScript or the like). Such a script can, for example, execute a search for certain keywords within a webpage's source (e.g., “embedurl,” “itemid,” etc.) to identify a video URL. In other cases, a script can find an identifier associated with a video and then construct a video URL using that identifier in association with other elements of a URL specific to the domain of the webpage that the script used to find the identifier. For any embodiment described in this application, a custom script of the inventive subject matter that is configured to create or identify a video URL for a particular domain can exist in a file or database containing multiple scripts, each configured to handle a different domain, or each individual custom script can be self-contained in its own file or database. In instances where a custom script is described as existing in a database, it can alternatively be interpreted as existing in a file, and vice versa. General scraper scripts, mentioned above, can similarly be incorporated into the same file or database as custom scripts. In some embodiments, a general scraper can be stored in a file or database that is separate from files or databases containing one or more custom scripts.

Upon executing an extraction script and discovering (or creating) a video URL, the platform server moves to the steps described above that can occur when a video URL is detected. For example, the service platform can save the video URL to a database according to step 210, or it can transmit the video URL to the client and the client can save the video URL to the database according to step 206. In any event, the video content is accordingly made accessible on the service platform such that other users can easily access the video content. In some embodiments, video content is made accessible on the service platform, e.g., via video URL without actually saving a copy of the video content to the service platform (e.g., no content is cached or stored on the service platform).

If the service platform executes a script according to step 212 and fails to find, extract, or otherwise create a video URL, then the service platform can alternatively send webpage metadata to the client, write webpage metadata to the database, or both. The webpage metadata can include the webpage URL and other information about the webpage that facilitate accessing the webpage via, e.g., a web browser.

As mentioned above, embodiments of the inventive subject matter can be implemented such that, instead of a user having a client device, a crawler, scraper, or other software-based non-human (referred to as a “crawler” hereinafter for simplicity) can go through many of the same steps with only minor modification. A crawler is an automated tool that collects information from different parts of the internet and, e.g., makes that information more easily accessible. In some instances, increased accessibility involves indexing webpages, and in the context of the inventive subject matter, a crawler would be designed to search, e.g., the internet, websites, or various standalone applications for video content.

Thus, FIG. 3 shows steps of an embodiment of the inventive subject matter that is directed to a crawler instead of a human user with a client devise. It should be understood that a crawler is operated by one or more computing devices (e.g., a server, a personal computer, a cloud service etc.). In some embodiments, the crawler is operated by the service platform, while in others the crawler operates in association with, but nevertheless separate from, the service platform. In step 200, a crawler visits a website having video content. It is contemplated that a crawler can access both websites and standalone applications in its efforts to discover video content and to go through steps of the inventive subject matter.

Next, in step 302, the crawler transmits information from the website having video content to the service platform. The information transmitted can include one or more of a website URL, a video URL, or other metadata such as a video identifier. In step 304, the service platform analyzes the information transmitted to it from the crawler in an effort to extract a video URL. If a video URL is detected, then the service platform saves that video URL to a database that the service platform has access to as with step 210, above. Once the video URL is saved to the database, video content corresponding to that video URL is made accessible on the service platform according to step 308 so that platform users can access the video content (e.g., users on the app can find and watch the video content).

In situations where no video URL is detected, the service platform identifies and executes a custom script that enables the service platform to extract a video URL according to step 310. This step is contemplated to be the same as step 212 described above in which the service platform identifies a script to execute according to a website's domain name, and that script enables the service platform to extract or create a video URL. In cases where a video URL is extracted or created, the service platform can then move to step 306. But in some cases, a video URL cannot be extracted or created even after executing a custom script according to step 310. In those cases, the service platform returns metadata instead.

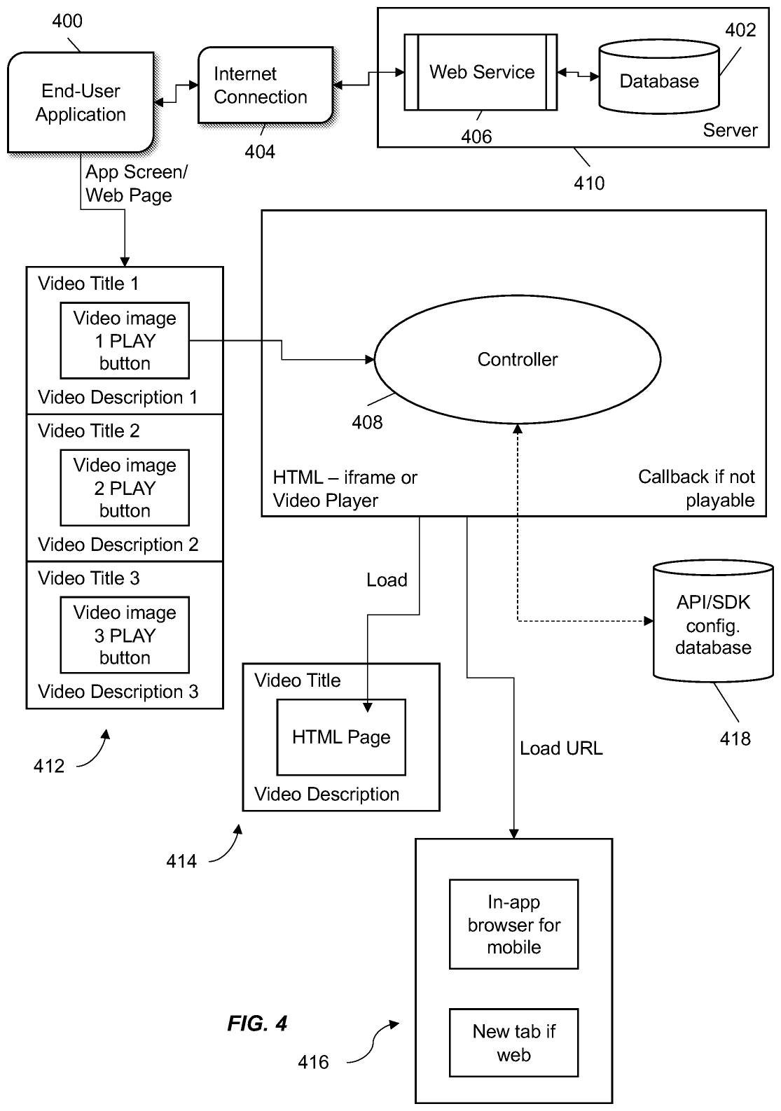

Video content is thus made accessible to service platform users according to the steps described above, and FIG. 4 shows how that video content can subsequently be accessed. FIG. 4 shows how an end-user application 400 (e.g., an application configured to interact with a service platform of the inventive subject matter, referred to as “the app” above) can access a database 402 over internet connection 404 to present to a user a visual listing of video content. The user can select a video, and a controller 408 can then determine how best to present that video to the user, based on, e.g., the video's source (e.g., video URLs from sources like YouTube, Facebook, and Vimeo, as well as direct video link, etc.). An end-user application 400 (e.g., an app, a website, or an over the top (OTT) system) can run on a mobile device, a television, a computer, a smart home hub, an infotainment system in a vehicle, or any other electronic device with an internet connection and an ability to display video. OTT refers to content providers that distribute streaming media as a standalone product directly to viewers over the Internet, bypassing telecommunications, multichannel television, and broadcast television platforms that traditionally act as a controller or distributor of such content.

As described above, end-user application 400 has access to database 402. A user's device running end-user application 400 can access database 402 via internet connection 404. Through internet connection 404, end-user application 400 allows the user to communicate with one or more web services 406, where the one or more web services 406 are configured to access database 402. In some embodiments, end-user application 400 can directly access database 402 without going through a web service.

Database 402 (which is maintained by the service platform) stores, among other things, video metadata (e.g., without storing actual video files). Video metadata can include information relating to remotely stored video content including, e.g., a video ID, a webpage URL, a video source (which can be a video source URL or an embed URL), a title, an image (e.g., a cover image, a still image from the video, etc.), a description, a manual category (e.g., a manually-set category), a predicted category (e.g., an algorithmically-set category), a prediction score (e.g., a score in percent that indicates predicted category confidence), one or more keywords associated with a video, and so on. These types of video metadata can apply to all embodiments described in this application. Database 402 can be maintained by the service platform, either on a service platform server or on a remote server.

In some embodiments, end-user application 400 requests a listing of video content from database 402 via web service 406, and web service 406 then retrieves video metadata from database 402 before passing that information back to end-user application 400 to be displayed to a user to select from. In such embodiments, all information necessary for making a video selection, embedding video, and beginning video playback (e.g., including an input URL) is retrieved and made accessible to the controller without initiating any additional requests (e.g., a request comprising a video selection intended to retrieve an input URL) after the initial request for video metadata. In some embodiments, the controller (e.g., code/software making up the controller) resides on service platform servers, not necessarily in, e.g., an end-user application. Information and other data is passed to the controller (e.g., from the database) where it can be used to carry out various steps of the inventive subject matter described in this application. It is contemplated that an input URL can be a video URL as described regarding embodiments above.

In some embodiments, to access database 402, end-user application 400 sends a video selection request via internet connection 404 to a web service 406 (e.g., a rest API that facilitates communication between database 402 and end-user application 400) that can access the requested information in database 402, where web service 406 and the database can exist (as shown in FIG. 4) on the service platform's backend server 410. In some embodiments, web service 406 is operated by a third party while database 402 is maintained on service platform server(s), or any combination of web service 406 and database 402 being operated/maintained by a third party or by the service platform. Web-service 406 can then send a response back to end-user application 400, the response including at least an input URL (e.g., a webpage URL, an embed URL, or a video source URL) that controller 408 can use to initiate video embedding or playback.

There are at least three contemplated possibilities for an input URL, which can lead to embedding or playback of a video in several ways. The input URL can be a webpage URL (e.g., a link to a webpage where a video is embedded), an embed URL (e.g., an embed link from a platform like YouTube), or a video source URL (e.g., a link directly to a video file). A controller of the inventive subject matter can be configured to handle each of those possibilities (using one or any combination of, e.g., PHP, JavaScript, and HTML).

In some embodiments, controller 408 can have access to second database 418 that stores, e.g., controller configuration and initialization settings (which can include, e.g., embedding instructions for each video platform). Configuration and initialization settings can include, for example, information sufficient to allow the controller to recognize input URLs as belonging to particular video platforms that have an available API or SDK, and the controller can then access that API or SDK based on the configuration and initialization settings stored on second database 418. The term “video platforms,” as used in this application, should be interpreted to include any video platform (e.g., YouTube, Vimeo, Facebook), website, or video publisher (e.g., websites that are not necessarily video platforms but that nevertheless publish videos, such as CNN or other media outlets) that makes video content available online.

In the absence of second database 418 storing configuration and initialization settings, one way to update a controller would be to edit the hard coding of the controller, but that can be impractical and can lead to introduction of bugs. Thus, an advantage of maintaining second database 418 is that controllers of the inventive subject matter would not need to be hard code updated each time support for a new website/video sharing platform having an available API or SDK is added to the service platform. Because second database 418 is not a necessary feature, it is shown as being connected to controller 408 via a dotted line. In embodiments that do not have second database 418, controller configuration and initialization settings are stored in controller 408 itself and updates to these configuration and initialization settings involve updating the controller's source code that must be pushed the service platform, which can result in down time or introduction of bugs that affect the entire service platform. Maintaining second database 418 can reduce or eliminate these types of problems and improve update efficiency by eliminating the need to revise controller source code just to add support for a new video platform. It is also contemplated that a service platform administrator can update second database 418 to add new video platforms via, e.g., a backend user interface that facilitates communication with second database 418. Because inclusion of second database 418 allows for a single update to be pushed to second database 418 to include new APIs/SDKs for new websites and platforms that can affect all users of the service platform, including second database 418 can lead to efficiency improvements when it comes to updates because it would eliminate a need to push source code updates to the service platform when all that is really needed is new configuration and initialization settings that each controller can access.

Databases of the inventive subject matter can be populated with video metadata in several ways, some of which are described above regarding FIGS. 1-3. In some embodiments, as shown in FIG. 2, users can browse the internet and then, when they see a video they like, they can add it to the database using, e.g., a browser plugin that pulls metadata associated with that video into the database, a share button that can share a video directly to the service platform, or by copying a URL and pasting it into the service platform via, for example, an app or the service platform's website. In some embodiments, as shown in FIG. 3, web crawlers deployed by the service platform can be used to identify video content (e.g., either on websites or standalone applications) and then pull video metadata into the database. Both of these methods can be implemented in some embodiments, creating a larger library of video content that users of the service platform can browse through. Each database entry (e.g., each entry corresponding to a video) includes sufficient video metadata to allow users of the service platform to access videos via the service platform. One advantage the service platform confers is that video content hosted elsewhere on the internet can be played back on the service platform with all originally intended advertisements included with the video. This allows video platforms to continue to benefit from viewership that comes via the service platform (e.g., by continuing to collect ad revenue), thus creating an incentive for video platforms to support the service platform. Although database 402 is visually depicted as a single database, it should be understood that an end-user application 400 can access any number of databases to access video metadata stored thereon, whether database 402 is controlled by the service platform or otherwise.

When a user shares a video to the service platform, the service platform receives that video and proceeds to add the video's metadata to its database. If the server detects that the video is from a new source (e.g., a platform, website, etc.), it can either automatically add configuration and initialization settings for the new source to the controller or to the second database, or it can flag the new source as requiring the controller or the second database to be updated by an administrator of the service platform.

In some embodiments, when a video selection is made, end-user application 400 creates a video selection request to send to database 402 via internet connection 404 and using a web service 406 to retrieve additional information from database 402. In other embodiments, it is contemplated that the listing of videos sent to the user for display and selection includes sufficient information that an additional video selection request is unnecessary. Instead, when a user makes a selection using end-user application 400, controller 408 receives that selection and makes a determination as to how to play the selected video back to the user.

In embodiments where a user makes a video selection and the controller sends a second request for additional video metadata, before an end-user application 400 can send a video selection request, end-user application 400 must first receive an input from a user, where the input comprises a video selection. To facilitate video selection, end-user application 400 can display a listing of videos that can be selected by a user. To display this listing, end-user application 400 retrieves a listing of selectable videos from database 402 via web service 406. Once the listing has been retrieved, end-user application 400 can then display the listing to a user. A listing can include, e.g., text describing each video, a still image from each video, a looping preview video from each video, a series of still images from each video strung together in a repeating animation, the video source, the video format, etc.

The user can then make a selection by providing an input to end-user application 400. Selections can be made by, for example, tapping on a desired video with a touch screen, clicking on an icon with a mouse using a PC, etc. An example listing is shown in listing 412, showing three videos, each having an associated video title, video description, and a video image play button. It is contemplated that one or any combination of video title, video description, and a video image play button can be displayed to a user without deviating from the inventive subject matter. All that is required is some visual representation of each video (e.g., at least one of an image, text, etc.) that user can interact with to select a video. In embodiments where end-user application 400 retrieves video metadata sufficient to initiate embedding/playback. The user's input amounting to a video selection causes the controller to receive the input URL associated with that video without an additional video selection request being generated and sent to database 402.

As mentioned above, in some embodiments, video metadata is retrieved from database 402 before a user makes a video selection. In such embodiments, end-user application 400 does not need to send a video selection request to retrieve sufficient metadata (e.g., an input URL) to play a video. Instead, end-user application 400 receives a user's selection and, according to that selection, end-user application 400 can pass along sufficient information to controller 408 (e.g., an input URL associated with the selected video) so that controller 408 can determine how best to present the selected video to the user via end-user application 400. Thus, a user's video selection can ultimately cause end-user application 400 to send a playback request comprising at least an input URL to controller 408, which runs on the service platform, and controller 408 can then determine how best to display (and ideally, embed) the video on the device running the end-user application.

As shown in FIG. 4, once a video selection is made and video metadata is passed on to or otherwise made available to controller 408, controller 408 determines whether the video can be played within end-user application 400 (see step 414) or if the video should be loaded by opening the webpage where the video can be viewed by visiting a page URL in a web browser (see step 416). In instances where video embedding can be accomplished within end-user application 400, an iframe (or, e.g., a div section in HTML) or video player is inserted into HTML body code so the video can be presented to the user. In instances where video embedding cannot be done within end-user application 400, controller 408 can cause end-user application 400 to launch a web browser to display the webpage where the video was originally made available for playback (e.g., the webpage where the video was originally embedded).

The web browser can be, for example, an in-app browser for mobile, a standalone browser, or it can be a new window or tab in a browser on a computer. In some embodiments, put broadly, when a user makes a video selection, the end-user application checks to see whether a video source entry exists in the database for the selected video (as entered according to steps detailed in FIGS. 2 and 3), and, if it exists, the video source entry would include either an embed URL or a video source URL, which the controller can then use to embed or playback the selected video. If no video source entry exists for the selected video (or the entry is otherwise invalid), then a webpage URL corresponding to the selected video in the database is sent via callback to the controller. This is discussed in more detail below. In some embodiments, on the other hand, it is contemplated that a webpage URL and either an embed URL or a video source URL (or both) can be passed to the controller, and the controller can then determine which input URL to use in executing steps of the inventive subject matter.

Thus, specific systems and methods directed to the aggregation of video URLs have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of aggregating video content to a service platform, the method comprising the steps of:
receiving, by the service platform from a client device, video metadata corresponding to a video accessible via a video content source;
analyzing, by the service platform, the video metadata to extract a video URL from the video metadata; and
saving the video URL to a database.

2. The method of claim 1, further comprising the step of making the video accessible to other users by making the video URL stored in the database accessible to the other users of the service platform.

3. The method of claim 1, wherein the video content source comprises at least one of a webpage and a standalone application.

4. The method of claim 1, wherein the video metadata comprises a URL.

5. The method of claim 1, further comprising the step of transmitting, by the service platform, the video URL to the client device.

6. The method of claim 1, wherein the step of extracting the video URL comprises creating the video URL using at least a portion of the video metadata.

7. A method of aggregating video content to a service platform, the method comprising the steps of:
receiving, by the service platform from a crawler, video metadata corresponding to a video that is accessible via a video content source;
detecting, by the service platform, whether a video URL can be extracted or created using the video metadata;
upon determining the video URL cannot be extracted or created using the video metadata, identifying a custom script configured to extract the video URL;
wherein the custom script is identified based on at least a domain of the video content source;
executing the custom script; and
saving, by the service platform, the video URL to a database.

8. The method of claim 7, further comprising the step of making the video accessible to other users by making the video URL stored to the database accessible to the other users of the service platform.

9. The method of claim 7, wherein the video content source comprises at least one of a webpage and a standalone application.

10. The method of claim 7, wherein the video metadata comprises a URL.

11. The method of claim 7, wherein the step of executing the custom script comprises creating the video URL using at least a portion of the video metadata.

12. A method of aggregating video content to a service platform, the method comprising the steps of:
receiving, by the service platform from a client device, video metadata corresponding to a video that is accessible via a video content source;
detecting, by the service platform, whether a video URL can be extracted or created using the video metadata;
upon determining the video URL cannot be extracted or created using the video metadata, identifying a custom script configured to extract the video URL;
wherein the custom script is identified based on at least a domain of the video content source;
executing the custom script; and
saving, by the service platform, the video URL to a database.

13. The method of claim 12, further comprising the step of making the video accessible to other users by making the video URL stored to the database accessible to the other users of the service platform.

14. The method of claim 12, wherein the video content source comprises at least one of a webpage and a standalone application.

15. The method of claim 12, wherein the video metadata comprises a URL.

16. The method of claim 12, further comprising the step of transmitting, by the service platform, the video URL to the client device.

17. The method of claim 12, wherein the step of executing the custom script comprises creating the video URL using at least a portion of the video metadata.
